(19) United States
(12) Patent Application Publication
(10) Pub. No.: US 2025/0317088 A1
(43) Pub. Date: Oct. 9, 2025

(54) MOTOR DRIVING APPARATUS AND METHOD FOR DETERMINING TEMPERATURE OF POWER MODULE

(71) Applicants: Hyundai Motor Company, Seoul (KR); Kia Corporation, Seoul (KR)

(72) Inventors: Yeong Ju Koh, Suncheon-Si (KR); Je Hwan Lee, Seongnam-Si (KR); Young Su Ko, Hwaseong-Si (KR)

(73) Assignees: Hyundai Motor Company, Seoul (KR); Kia Corporation, Seoul (KR)

(21) Appl. No.: 18/938,579

(22) Filed: Nov. 6, 2024

(30) Foreign Application Priority Data
Apr. 9, 2024 (KR) 10-2024-0048188

(51) Int. Cl. H02P 29/68

(52) U.S. Cl. CPC H02P 29/68

(57) ABSTRACT

A motor driving apparatus includes: a driving unit which is implemented as at least one power module and includes a top switch, a bottom switch, and a changeover switch configured to switch a motor driving mode; and a controller configured to determine a power loss of each of the top switch, the bottom switch, and the changeover switch to obtain a total power loss of the at least one power module, and determine a temperature of the at least one power module based on the total power loss.

### CROSS-REFERENCE TO RELATED APPLICATION(S)

The present application claims priority to Korean Patent Application No. 10-2024-0048188, filed on Apr. 9, 2024, the entire contents of which is incorporated herein for all purposes by this reference.

### BACKGROUND OF THE PRESENT DISCLOSURE

### Field of the Present Disclosure

The present disclosure relates to a method for determining the temperature of a power module in a motor driving apparatus.

### Description of Related Art

Generally, one-side ends of windings having respective phases included in a motor of an electric vehicle are connected to one inverter and the other-side ends are connected to each other, forming a Y-connection.

When the motor is driven, a switching element in the inverter is switched on or off by pulse width modulation control to apply a line-to-line voltage to the Y-connected windings of the motor to generate alternating current, generating torque.

Since the fuel efficiency (or electricity cost) of eco-friendly vehicles such as electric vehicles that use the torque generated by the motor as power is determined by inverter-motor power conversion efficiency, it is important to maximize the power conversion efficiency of the inverter and the efficiency of the motor to improve fuel efficiency.

The efficiency of an inverter-motor system is mainly determined by the voltage utilization rate of the inverter, and the fuel efficiency of the vehicle may be improved when the vehicle's operation point, which is determined by the relationship between the speed and torque of the motor, is formed in a section with a high voltage utilization rate.

However, as the number of windings of the motor is increased to enhance the maximum torque of the motor, a section with a high voltage utilization rate may be farther away from a low torque region, which is the main operation point of the vehicle, resulting in poor fuel efficiency. Furthermore, designing the main operation point to be included in the section with a high voltage utilization rate from a fuel efficiency perspective may limit the maximum torque of the motor, reducing the acceleration launch performance of the vehicle.

In the present field of the present disclosure, there is a demand for motor drive technology that can cover both low- and high-power intervals with a single motor while improving system efficiency is required. Therefore, recently, a technology that utilizes two inverters and changeover switches to drive a single motor in two different modes has been introduced.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to determining the temperature of a power module in consideration of a motor driving mode and the operation state of a motor.

The technical subjects pursued in an exemplary embodiment of the present disclosure may not be limited to the above-mentioned technical subjects, and other technical subjects which are not mentioned may be clearly understood, through the following descriptions, by those skilled in the art to which the present disclosure pertains.

As a means of addressing the above technical aspect, a motor driving apparatus according to an exemplary embodiment of the present disclosure may include: a driving unit which is implemented as at least one power module including at least one switch and includes a top switch and a bottom switch configured to drive a motor based on a motor driving mode and a changeover switch configured to switch the motor driving mode; and a controller configured to determine a power loss of each of the top switch, the bottom switch, and the changeover switch based on the motor driving mode and an operation state of the motor to obtain a total power loss of the at least one power module, and determine a temperature of the at least one power module based on the total power loss.

Furthermore, as a means of addressing the above technical aspect, a method for determining a temperature of at least one power module including at least one switch, in a driving unit which is implemented as the at least one power module and includes a top switch and a bottom switch configured to drive a motor based on a motor driving mode and a changeover switch configured to switch the motor driving mode, may include: determining a power loss of each of the top switch, the bottom switch, and the changeover switch based on the motor driving mode and an operation state of the motor to obtain a total power loss of the at least one power module; and determining a temperature of the at least one power module based on the total power loss.

According to an exemplary embodiment of the present disclosure, the accuracy of estimation of the temperature of the at least one power module may be improved by determining the temperature of the at least one power module in consideration of the motor driving mode and the operation state of the motor without a separate temperature sensor, and switch elements in the at least one power module may be protected by controlling a current in the at least one power module based on the determined temperature.

Advantageous effects obtainable from the present disclosure may not be limited to the above-mentioned effects, and other effects which are not mentioned may be clearly understood, through the following descriptions, by those skilled in the art to which the present disclosure pertains.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a circuit diagram according to one example of a motor driving apparatus according to an exemplary embodiment of the present disclosure.

FIG. 2 illustrates switching of a motor driving mode according to an exemplary embodiment of the present disclosure.

FIG. 3 illustrates the configuration of a power module according to an exemplary embodiment of the present disclosure.

FIG. 4 is a flowchart illustrating a method for determining the temperature of a power module by a controller according to an exemplary embodiment of the present disclosure.

FIG. 5 illustrates a process in which a controller according to an exemplary embodiment of the present disclosure is configured to determine power losses of a top switch and a bottom switch of a power module in a CEW mode.

FIG. 6 is a graph corresponding to an IV curve of a switch element included in a power module according to an exemplary embodiment of the present disclosure.

FIG. 7 illustrates a process in which a controller according to an exemplary embodiment of the present disclosure is configured to determine power losses of a top switch and a bottom switch of a power module in an OEW mode.

FIG. 8 illustrate a process in which a controller according to an exemplary embodiment of the present disclosure measures the thermal resistance of a power module.

FIG. 9 illustrates a process in which a controller according to an exemplary embodiment of the present disclosure corrects a thermal resistance measurement value of a power module based on a coolant flow rate of the power module.

FIG. 10 illustrates a process in which a controller according to an exemplary embodiment of the present disclosure correct the temperature variation of a power module.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments set forth herein will be described in detail with reference to the accompanying drawings, and the same or similar elements are provided the same and similar reference numerals regardless of figure numbers, so duplicate descriptions thereof will be omitted. The terms “module” and “unit” used for the elements in the following description are provided or interchangeably used in consideration of only the ease of writing the specification, and do not have distinct meanings or roles by themselves. Furthermore, in describing the exemplary embodiments set forth herein, a detailed description of known relevant technologies will be omitted when it is determined that the description may make the subject matter of the present disclosure obscure. Furthermore, it should be appreciated that the accompanying drawings are provided only for the sake of easy understanding of the exemplary embodiments set forth herein, and the technical idea of the present disclosure is not limited to the accompanying drawings and includes all modifications, equivalents, or alternatives falling within the spirit and scope of the present disclosure.

Terms including an ordinal number such as “a first” and “a second” may be used to describe various elements, but the elements are not limited to the terms. The above terms are used merely for distinguishing one element from other elements.

In the case where an element is referred to as being “connected” or “coupled” to any other elements, it should be understood that not only the element may be directly connected or coupled to the other elements, but also another element may exist therebetween. Contrarily, in the case where an element is referred to as being “directly connected” or “directly coupled” to any other element, it should be understood that no other element exists therebetween.

A singular expression may include a plural expression unless they are definitely different in a context.

As used herein, the expression “comprise”, “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

A unit or a control unit included in names such as a motor control unit (MCU) is merely a term widely used for naming a controller configured to control a predetermined function of a vehicle, but does not mean a generic function unit. For example, to control a function that a control unit is responsible for, each control unit may include a communication device configured to communicate with a sensor or another control unit, a memory configured to store an operation system, a logic command, or input/output information, and at least one processor configured to perform determination, calculation, decision or the like which are required for responsible function controlling.

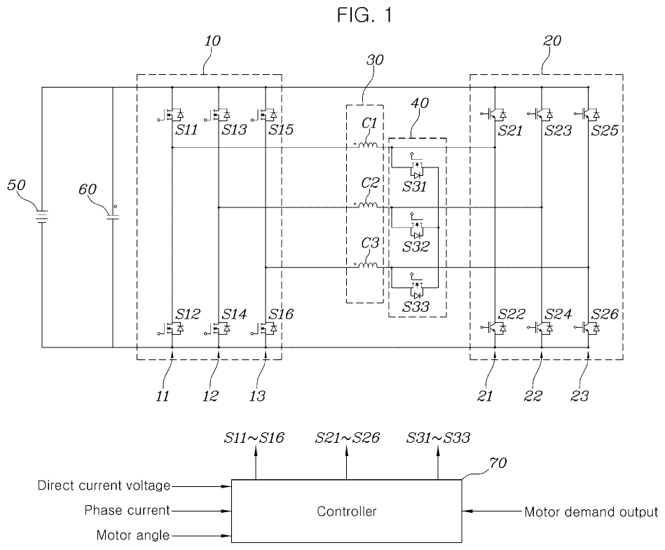

FIG. 1 is a circuit diagram according to one example of a motor driving apparatus according to an exemplary embodiment of the present disclosure.

Referring to FIG. 1, a motor driving apparatus according to various exemplary embodiments of the present disclosure may include a first inverter 10, a second inverter 20, a motor 30 including a plurality of windings C1, C2, and C3 corresponding to multiple phases, a mode switching unit 40, a battery 50, a direct current capacitor (or a DC-Link capacitor) 60, and a controller 70.

The first inverter 10 may include a plurality of first switching elements S11, S12, S13, S14, S15 and S16 connected to one-side ends of the plurality of windings C1, C2, and C3, and the second inverter 20 may include a plurality of second switching elements S21, S22, S23, S24, S25 and S26 connected to the other-side ends of the plurality of windings C1, C2, and C3. The mode switching unit 40 may include a plurality of changeover switches S31, S32, and S33 connected between the other-side ends of the plurality of windings C1, C2, and C3 and a neutral end for the plurality of windings C1, C2, and C3. The controller 70 may be configured for controlling the ON/OFF state of the first switching elements S11, S12, S13, S14, S15 and S16, the second switching elements S21, S22, S23, S24, S25 and S26, and the changeover switches S31, S32, and S33 based on a motor demand output (i.e., a torque command to the motor), DC link voltages of the inverters 10 and 20 (i.e., a voltage of the battery), a phase current of the motor, and a motor angle.

The first inverter 10 may include a plurality of legs 11, 12, 13 to which a direct current voltage formed in a direct current capacitor 60 connected between both ends of the battery 50 is applied. The legs 11, 12, and 13 may be electrically connected to multiple phases of the motor 30, respectively. The first leg 11 may include two switching elements S11 and S12 connected in series to each other between both ends of the direct current capacitor 60, and a connection node of the two switching elements S11 and S12 may be connected to one end of the winding C1 of one phase in the motor 30 so that alternating current power corresponding to one of the multiple phases is input and output. Similarly, the second leg 12 may include two switching elements S13 and S14 connected in series to each other between both ends of the direct current capacitor 60, and a connection node for the two switching elements S13 and S14 may be connected to one end of the winding C2 of one phase in the motor 30 so that alternating current power corresponding to one of the multiple phases is input and output. Furthermore, the third leg 13 may include two switching elements S15 and S16 connected in series to each other between both ends of the direct current capacitor 60, and a connection node for the two switching elements S15 and S16 may be connected to one end of the windings C3 of one phase in the motor 30 so that alternating current power corresponding to one of the multiple phases is input and output.

The second inverter 20 may include a plurality of legs 21, 22, and 23 to which a direct current voltage formed in the direct current capacitor 60 connected between both ends of the battery 50 is applied. The legs 21, 22, and 23 may each be electrically connected to multiple phases of the motor 30. The first leg 21 may include two switching elements S21 and S22 connected in series to each other between both ends of the direct current capacitor 60, and a connection node for the two switching elements S21 and S22 may be connected to the other end of the winding C1 of one phase in the motor 30 so that alternating current power corresponding to one of the multiple phases is input and output. Similarly, the second leg 22 may include two switching elements S23 and S24 connected in series to each other between both ends of the direct current capacitor 60, and a connection node for the two switching elements S23 and S24 may be connected to the other end of the winding C2 of one phase in the motor 30 so that alternating current power corresponding to one of the multiple phases is input and output. Furthermore, the third leg 23 may include two switching elements S25 and S26 connected in series to each other between both ends of the direct current capacitor 60, and a connection node for the two switching elements S25 and S26 may be connected to the other end of the winding C3 of one phase in the motor 30 so that alternating current power corresponding to one of the multiple phases is input and output.

One-side ends of the plurality of changeover switches S31, S32, and S33 may be connected to the other-side ends of the plurality of windings C1, C2, and C3 included in the motor 30, while the other-side ends of the plurality of changeover switches S31, S32, and S33 may be interconnected at the neutral end of the motor 30. Various switching means known in the art, such as MOSFETs, IGBTs, thyristors, relays, and the like, may be employed for the plurality of changeover switches S31, S32, and S33.

Although not shown in FIG. 1, the motor driving apparatus may further include a so-called Y-capacitor (Y-Cap), which connects two capacitors connected in series to each other between a positive (+) DC link and a negative (−) DC link, and grounds a connection node between the capacitors.

The controller 70 may be configured for controlling the driving of the motor 30 by switching the switching elements S11, S12, S13, S14, S15 and S16 and S21, S22, S23, S24, S25 and S26 included in the first inverter 10 and the second inverter 20 through pulse width modulation control, based on the demand power output required by the motor 30.

Furthermore, the controller 70 may control, based on motor driving modes, the ON/OFF state of the third switching elements S31, S32, and S33 included in the mode switching unit 40. The motor driving modes may include a first driving mode and a second driving mode. The first driving mode may be referred to as a “closed-end winding (CEW) mode”, and the second driving mode may be referred to as an “open-end winding (OEW) mode”.

The controller 70 may be configured for controlling the changeover switches S31, S32, and S33 to be in an ON state when the CEW mode is executed, and may be configured for controlling the driving of the motor 30 through the first inverter 10 among the two inverters 10 and 20. The changeover switches S31, S32, and S33 in the ON state may electrically connect the other-side ends of the plurality of windings C1, C2 and C3 to the neutral end for the plurality of windings C1, C2 and C3, respectively.

In contrast, the controller 70 may be configured for controlling the changeover switches S31, S32, and S33 to be in an OFF state when the OEW mode is executed, and may be configured for controlling the driving of the motor 30 through the two inverters 10 and 20. The changeover switches S31, S32, and S33 in the OFF state may electrically disconnect the other-side ends of the plurality of windings C1, C2 and C3 from the neutral end for the plurality of windings C1, C2 and C3, respectively.

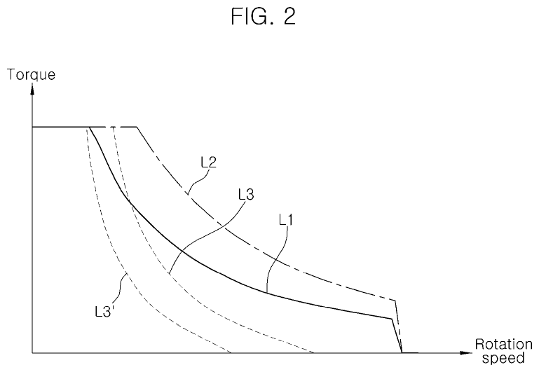

FIG. 2 illustrates switching of a motor driving mode according to an exemplary embodiment of the present disclosure.

FIG. 2 illustrates a motor operation point map showing an output limit curve L1 in a CEW mode, an output limit curve L2 in an OEW mode, and a mode switching reference line L3 based on an efficiency map.

The output limit curves L1 and L2 may represent output torque limit values of the motor at each rotation speed (e.g., RPM) of the motor in the respective motor driving modes. The output limit curve L2 may include an output limit greater than or equal to that of the output limit curve L1 in at least some revolutions per minute (rpm) regions, and the output limit curves L1 and L2 may be configured in consideration of the durability, heat-generation capability, and current controllability of the motor and the inverter.

The mode switching reference line L3 based on the efficiency map may correspond to the boundary between a high-efficiency region in the CEW mode and a high-efficiency region in the OEW mode. The efficiency map may include information related to which of the CEW mode and the OEW mode is more efficient at each combination of torque and inverse magnetic flux of the motor, and may take the form of a table, depending on the implementation. For example, the efficiency map may be derived based on the result of measuring, through tests, the loss of the motor according to the rotation speed and torque of the motor in each motor driving mode for each DC link voltage of the inverter. In the instant case, the inverse magnetic flux of the motor may be inversely proportional to the DC link voltage of the inverter (i.e., the voltage of the battery) and may be proportional to the speed of the motor.

According to an exemplary embodiment of the present disclosure, the mode switching reference line L3 may include the same shape as L3′ depending on the specification of the motor driving apparatus. However, the mode switching reference lines L3 and L3′ illustrated in FIG. 2 are exemplary, and the present disclosure is not necessarily limited thereto.

To switch the motor driving mode according to the mode switching reference line L3, the controller 70 may switch the CEW mode and the OEW mode in both directions according to the value of a torque command to the motor and the value of the inverse magnetic flux with reference to the efficiency map. In the instant case, the value of the inverse magnetic flux may be determined based on the torque command to the motor, the DC link voltage of the inverter, and the required speed of the motor. According to an exemplary embodiment of the present disclosure, the controller 70 may correct the mode switching reference line in consideration of an output limit or hysteresis in the motor driving mode, in the instant case, the motor driving mode may be switched according to the value of the torque command to the motor and the value of the inverse magnetic flux based on the calibrated mode switching threshold.

On the other hand, each switch element in the inverter may heat up to a high temperature due to a conduction loss and a switching loss that occur when being switched, and thus may be modularized in a form of a power module including a separate cooling structure. When the power module includes a temperature higher than a predetermined specification temperature, internal switch elements of the power module may burn out, so it is necessary to estimate the temperature of the power module and control the current of the power module based on the estimated temperature.

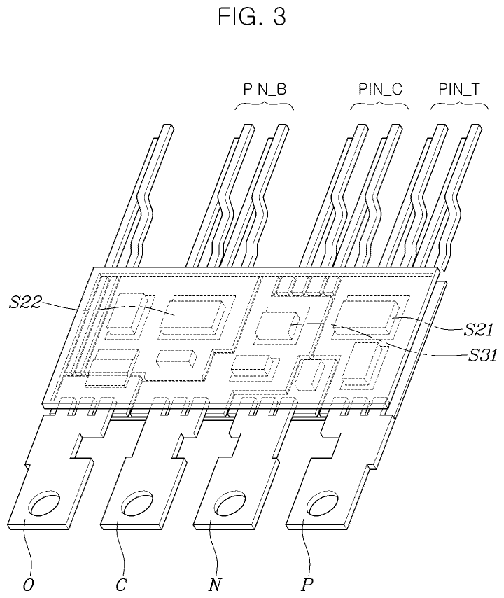

On the other hand, a driving unit according to an exemplary embodiment of the present disclosure may be implemented as at least one power module including at least one switch, and may include a top switch and a bottom switch configured to drive the motor based on the motor driving mode, and a changeover switch configured to switch the motor driving mode. For example, the driving unit may be implemented as a single power module including all of the top switch, the bottom switch, and the changeover switch. Alternatively, the driving unit may be implemented in a manner where the top switch, the bottom switch, and the changeover switch are distributed among a plurality of different power modules. The configuration of the power module for the implementation of the driving unit will be described with reference to FIG. 3.

FIG. 3 illustrates the configuration of a power module according to an exemplary embodiment of the present disclosure.

As illustrated in FIG. 3, the power module according to an exemplary embodiment of the present disclosure may include a top switch S21 and a bottom switch S22 included in the second inverter 20 and a changeover switch S31 included in the mode switching unit 40. The power module in the form illustrated in FIG. 3 has three switch elements, and thus may be referred to as a 3-in-1 power module. In the instant case, a top switch S23, a bottom switch S24, and a changeover switch S32 may form another 3-in-1 power module, and a top switch S25, a bottom switch S26, and a changeover switch S33 may form another 3-in-1 power module. Furthermore, a top switch and a bottom switch included in the first inverter 10 may also form a separate power module.

An output terminal O, a switching terminal C, a negative terminal N, and a positive terminal P may be disposed on one side of the power module, and control pins PIN_B, PIN_C, and PIN_T may be disposed on the other side opposite to the one side of the power module. The power module may receive signals for controlling the turn-on state of the top switch S21, the changeover switch S31, and the bottom switch S22 through the control pin PIN_B, the control pin PIN_C, and the control pin PIN_T, respectively. In the instant case, the top switch S21 may be disposed between the positive terminal P connected to a positive electrode of the battery and the output terminal O connected to one end of a winding included in the motor. The bottom switch S22 may be disposed between the negative terminal N, which is connected to the negative electrode of the battery, and the output terminal O, which is connected to the one end of the winding included in the motor. The changeover switch S31 may be disposed between the output terminal O, which is connected to the one end of the winding included in the motor, and the switching terminal C, which is connected to the neutral end of the motor.

Unlike the illustration in FIG. 3, the power module may also be implemented as a 5-in-1 power module including a top switch S11 and a bottom switch S12 included in the first inverter 10, the top switch S21 and the bottom switch S22 included in the second inverter 20, and the changeover switch S31 included in the mode switching unit 40.

Meanwhile, in the top switch S21 and the bottom switch S22 of the second inverter 20, which drive the motor based on the motor driving mode, and the changeover switch S31, which switches the motor driving mode, the power loss needs to be determined differently depending on the motor driving mode and the operation state of the motor.

The present disclosure proposes a method for determining, based on a motor driving mode and an operation state of a motor, the temperature of a power module including a switch element of a second inverter and a changeover switch. Hereinafter, for convenience of explanation, the present disclosure will be described assuming that the power module is a 3-in-1 power module. However, the present disclosure may be applied to various types of power modules such as 5-in-1 power modules.

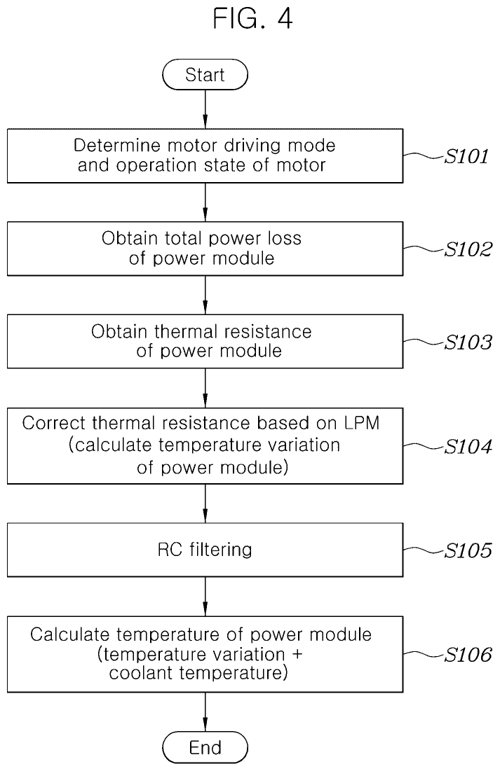

FIG. 4 is a flowchart illustrating a method for determining the temperature of a power module by a controller according to an exemplary embodiment of the present disclosure.

Referring to FIG. 4, the controller 70 may obtain a total power loss of the power module based on the motor driving mode and the operation state of the motor, and determine a temperature of the power module based on the total power loss of the power module, the thermal resistance measurement value, and the coolant temperature of the power module.

The temperature of the power module may be determined as shown in Equation 1 below.

$$Temperature of power module = Temperature variation of power module \times RC filter value + coolant temperature of power module . \qquad Equation 1$$

The RC filter value can be determined based on experimental data obtained by applying a current having a certain root mean square value to the driving unit and measuring the resulting temperature. The temperature variation of the power module may correspond to the product of the total power loss of the power module, the thermal resistance measurement value of the power module, and the coolant flow rate (LPM) correction constant, as shown in Equation 2 below.

$$Temperature variation of power module = Total power loss of power module \times Thermal resistance measurement value of power module \times \\ Coolant flow rate ( LPM ) correction constant \qquad Equation 2$$

First, the controller 70 may be configured to determine a motor driving mode and an operation state of the motor (S101).

The controller 70 may be configured to determine whether the motor driving mode is a CEW mode or an OEW mode. The CEW mode may correspond to a mode in which the top switch and the bottom switch included in the second inverter are turned off and the changeover switch included in the mode switching unit is turned on to form a neutral point of the motor. In contrast, the OEW mode may correspond to a mode in which the top switch and the bottom switch included in the second inverter are switched complementarily to drive the motor, and the changeover switch included in the mode switching unit is turned off.

Furthermore, the controller 70 may be configured to determine whether the operation state of the motor is a started state or a constrained state, based on a rotation speed (e.g., RPM) of the motor 30. The controller can obtain the rotation speed of the motor through a resolver or encoder, etc. The controller 70 may be configured to determine that the operation state of the motor is a constrained state when the rotation speed (RPM) is 0, and may be configured to determine that the operation state of the motor is a started state when the rotation speed (RPM) is not 0. Here, the started state may be defined as a state in which the motor is rotating while the torque of the motor is generated, and the constrained state may be defined as a state in which the motor is not rotating while the torque of the motor is generated. For example, the constrained state of the motor may correspond to the state in which the vehicle is stopped using an accelerator without brake operation when climbing.

Thereafter, the controller 70 may be configured to determine the power loss of each of the top switch, the bottom switch, and the changeover switch included in the power module based on the motor driving mode and the operation state of the motor to obtain the total power loss of the power module (S102).

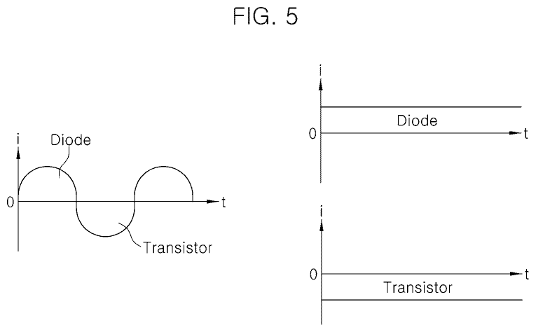

When the CEW mode is executed, the top switch and the bottom switch included in the second inverter are turned off, but the changeover switch is turned on, leading to conduction losses due to the phase current of the motor. Accordingly, when the CEW mode is executed, the controller 70 may be configured to determine a power loss of the changeover switch which is included in the total power loss of the power module. FIG. 5 illustrates a process in which the controller is configured to determine the power loss of the changeover switch of the power module in the CEW mode.

The left side of FIG. 5 illustrates the waveform of a motor current when the operation state of the motor in CEW mode is the started state. When a current is positive (+), a diode of the changeover switch may be conducted, and when the current is negative (−), a transistor of the changeover switch may be conducted. In the instant case, the current flowing in each phase of the three-phase motor may include an imax*sin (wt) waveform with a phase of 120 degrees.

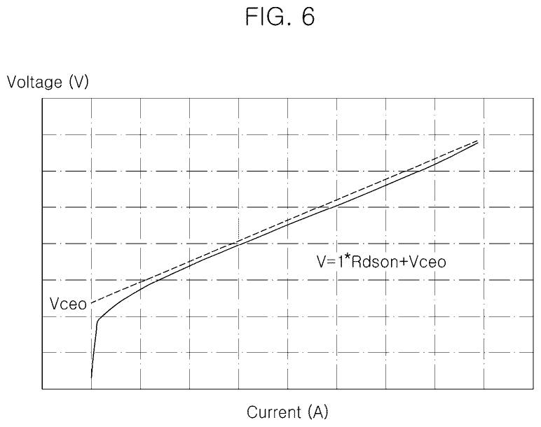

FIG. 6 illustrates a graph corresponding to an IV curve of a switch element. In the IV curve, the relationship between voltage and current follows the equation “V=I*Rdson+Vceo” at a certain current level or higher. Here, Vceo and Rdson may correspond to the characteristics of the IV curve. The power loss of a switch element may be expressed as the product of a voltage (V) and a current (I) of the switch element.

When the operation state of the motor in the CEW mode is the started state, the controller 70 may be configured to determine the transistor loss and diode loss of the changeover switch based on the maximum value (imax) of a sinusoidal current conducted to the changeover switch.

When the operation state of the motor in CEW mode is the started state, the transistor loss (Pigbt_split) of the changeover switch may be determined as shown in Equation 3 below.

$$Pigbt\_split = \frac{Vceo * i max}{π} + \frac{Rdson}{4} * i max \hat{} 2 \qquad Equation 3$$

When the operation state of the motor in CEW mode is the started state, the diode loss (Pdiode_split) of the changeover switch may be determined as shown in Equation 4 below. Here, Vo,diode and Rt,diode may correspond to the characteristics of the diodes corresponding to Vceo and Rdson, respectively.

$$Pdiode\_split = \frac{Vo , diode * i max}{π} + \frac{Rt , diode}{4} * i max \hat{} 2 \qquad Equation 4$$

The right side of FIG. 5 shows a waveform of a motor current when the operation state of the motor in CEW mode is the constrained state. As shown at the upper right side, when the current is positive (+), the diode of the changeover switch may be conducted, and as shown at the lower right side, when the current is negative (−), the transistor of the changeover switch may be conducted.

In the restrained state, the motor's rpm is zero, so unlike the started state, a conduction current in the constrained state does not include the form of a sinusoidal wave, but may include the form of a direct current. Therefore, since the formula for the started state, which may be determined assuming a sinusoidal wave, may not be used, and since the imax value may vary depending on the motor angle, the power loss may be determined using the phase current measurement value ∧i. Accordingly, when the operation state of the motor in the CEW mode is the constrained state, the controller 70 may be configured to determine the transistor loss or the diode loss of the changeover switch based on the phase current measurement value of the motor.

When the power loss is determined using the phase current measurement ∧i, in the constrained state, the frequency of the phase current is low enough to avoid aliasing, and a current value in each phase may be used. Therefore, the accuracy of the power loss determination may be improved, thus leading to improved temperature estimation performance.

When the operation state of the motor in CEW mode is the constrained state, the diode loss (Pdiode) of the changeover switch may be determined as shown in Equation 5 below. Here, Digbt refers to the duty ratio.

$$Pdiode = Di {gbt}^{*} \hat{} {i}^{*} ( Vo , diode + Rt , {diode}^{*} \hat{} i ) \qquad Equation 5$$

When the operation state of the motor in CEW mode is the constrained state, the transistor loss (Pigbt) of the changeover switch may be determined as shown in Equation 6 below.

$$Pigbt = {Digbt}^{*} \hat{} {i}^{*} ( Vceo + {Rdson}^{*} \hat{} i ) \qquad Equation 6$$

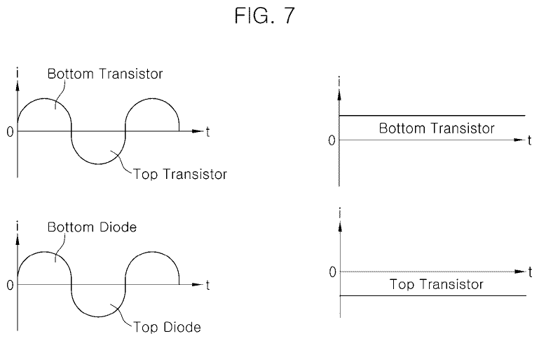

When the OEW mode is executed, the changeover switch is turned off, but the top switch and the bottom switch included in the second inverter are switched complementarily to drive the motor. Thus, conduction losses and switching losses may occur due to the phase current of the motor. Accordingly, when the OEW mode is executed, the controller 70 may be configured to determine power losses of the top switch and the bottom switch that are included in the total power loss of the power module. FIG. 7 illustrates a process in which the controller 70 is configured to determine the power losses of the top switch and the bottom switch of the power module in OEW mode.

The left side of FIG. 7 shows a waveform of a motor current when the operation state of the motor in the OEW mode is a started state. The upper left side shows a current waveform when the motor is supplied with power, wherein when the current is positive (+), the transistor of the bottom switch may be conducted, and when the current is negative (−), the transistor of the top switch may be conducted. Accordingly, when the operation state of the motor in the OEW mode is the started state and when the motor is supplied with power, the controller 70 may be configured to determine transistor losses of the top switch and the bottom switch based on the maximum value of sinusoidal current conducted to the top switch and the bottom switch. The lower left side shows a current waveform in a state where power is recovered from the motor, wherein when the current is positive (+), the diode of the bottom switch may be conducted, and when the current is negative (−), the diode of the top switch may be conducted. Accordingly, when the operation state of the motor in the OEW mode is the started state and the power is recovered from the motor (i.e., the regenerative braking state), the controller 70 may be configured to determine the diode losses of the top switch and the bottom switch based on the maximum value of sinusoidal current conducted to the top switch and the bottom switch.

The right side of FIG. 7 shows the waveform of a motor current when the operation state of the motor in the OEW mode is a constrained state. As shown at the upper right side, the transistor of the bottom switch may be conducted when the current is positive (+), and as shown at the lower right side, the transistor of the top switch may be conducted when the current is negative (−). Accordingly, when the operation state of the motor in the OEW mode is the constrained state, the controller 70 may be configured to determine a transistor loss of the top switch or a transistor loss of the bottom switch based on a phase current measurement value of the motor.

Thereafter, the controller 70 may obtain thermal resistance of the power module (S103). The thermal resistance of the power module may be determined while a cooler is coupled to the power module, and may be determined based on: a loss IV while a current flows to the corresponding element; and the temperature of the element when the current is conducted. The controller 70 may obtain the thermal resistance of the power module by receiving an externally determined or measured resistance of the power module. Alternatively, the controller 70 may directly determine the thermal resistance of the power module.

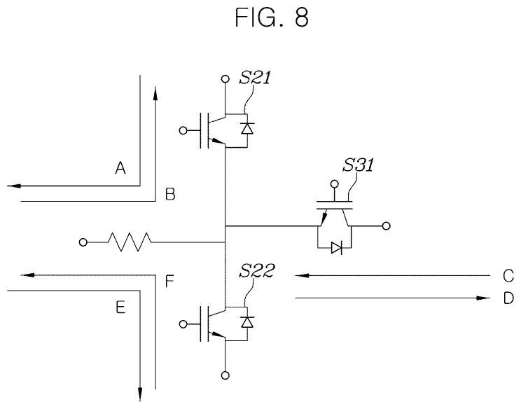

FIG. 8 illustrate a process in which the controller 70 according to an exemplary embodiment of the present disclosure measures the thermal resistance of the power module. “A” may correspond to a conduction direction of a current for measuring thermal resistance to a transistor of the top switch S21, and “B” may correspond to a conduction direction of a current for measuring thermal resistance to a diode of the top switch S21. Furthermore, “C” may correspond to a conduction direction of a current for measuring thermal resistance to a transistor of the changeover switch S31, and “D” may correspond to a conduction direction of a current for measuring thermal resistance to a diode of the changeover switch S31. Similarly, “E” may correspond to a conduction direction of a current for measuring thermal resistance to a transistor of the bottom switch S22, and “F” may correspond to a conduction direction of a current for measuring thermal resistance to a diode of the bottom switch S22.

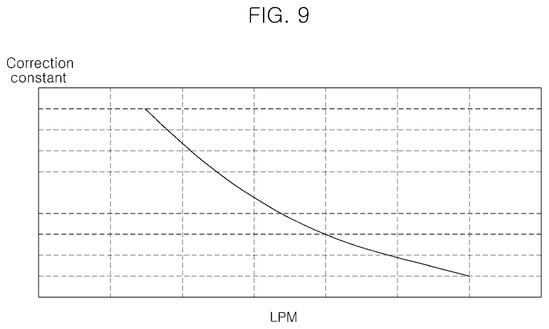

Meanwhile, when measuring the thermal resistance of the power module, the thermal resistance varies depending on the flow rate of a coolant flowing through the cooler of the power module, so that the controller 70 may multiply a thermal resistance measurement value by a coolant flow rate (LPM) correction constant to correct the thermal resistance measurement value of the power module, determining the temperature variation of the power module (S104). The coolant flow rate (LPM)-dependent correction constant is illustrated in FIG. 9. Referring to FIG. 9, it may be identified that as the flow rate (LPM) of the coolant increases, the value of the coolant flow rate (LPM) correction constant decreases. The controller can obtain the coolant flow rate (LPM) correction constant through a look-up table or formula that reflects the relationship between the flow rate (LPM) and the flow rate (LPM) correction constant, as shown in FIG. 9.

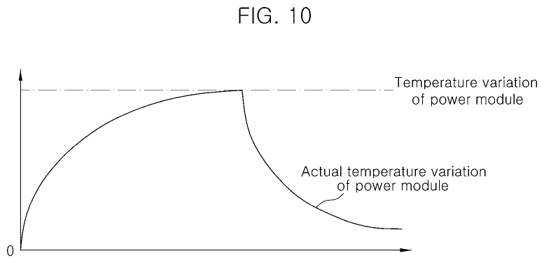

Since the temperature variation of the power module corresponds to the amount of change when the corresponding temperature is saturated, the controller 70 may, based on the Foster thermal model, multiply a temperature variation of the power module by an RC filter value to obtain the actual temperature variation of the power module modeled as an actual impedance (S105). FIG. 10 illustrates a process in which the controller is configured to obtain an actual temperature variation of the power module from the temperature variation of the power module.

Finally, the controller 70 may be configured to determine the internal temperature of the power module by adding a coolant temperature of the power module to the actual temperature variation of the power module obtained in operation S105 (S106). Furthermore, the controller 70 can control the operation of the driving unit, such as controlling the turn-on and turn-off of the top switch, the bottom switch, and the changeover switch, based on the internal temperature of the generated power module. In addition, the controller 70 can control the cooler, etc., based on the internal temperature of the generated power module.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A motor driving apparatus comprising:
a driving unit which is implemented as at least one power module including at least one switch and includes a top switch and a bottom switch configured to drive a motor based on a motor driving mode and a changeover switch configured to switch the motor driving mode; and
a controller configured to determine a power loss of each of the top switch, the bottom switch, and the changeover switch based on the motor driving mode and an operation state of the motor to obtain a total power loss of the at least one power module, and determine a temperature of the at least one power module based on the total power loss.

2. The motor driving apparatus of claim 1,
wherein the top switch is connected between a positive (+) electrode of a battery and one end of a winding included in the motor,
wherein the bottom switch is connected between a negative (−) electrode of the battery and the one end of the winding, and
wherein the changeover switch is connected between the one end of the winding and a neutral end of the motor.

3. The motor driving apparatus of claim 1, wherein the controller is further configured to determine, based on a rotation speed of the motor, whether the operation state is a started state or a constrained state.

4. The motor driving apparatus of claim 1, wherein the motor driving mode includes:
a first driving mode in which the top switch and the bottom switch are turned off, and the changeover switch is turned on to form a neutral point of the motor; and
a second driving mode in which the top switch and the bottom switch are switched complementarily to drive the motor, and the changeover switch is turned off.

5. The motor driving apparatus of claim 4, wherein the controller is further configured to:
determine the power loss of the changeover switch included in the total power loss in the first driving mode; and
determine the power losses of the top switch and the bottom switch included in the total power loss in the second driving mode.

6. The motor driving apparatus of claim 5,
wherein the operation state of the motor in the first driving mode includes a started state and a constrained state, and
wherein the controller is further configured to:
determine a transistor loss or a diode loss of the changeover switch based on a maximum value of a sinusoidal current conducted to the changeover switch in the started state; and
determine the transistor loss or the diode loss of the changeover switch based on a phase current measurement value of the motor in the constrained state.

7. The motor driving apparatus of claim 5,
wherein the operation state of the motor in the second driving mode includes a started state and a constrained state, and
wherein the controller is further configured to:
determine transistor losses of the top switch and the bottom switch based on a maximum value of a sinusoidal current conducted to the top switch and the bottom switch, in the started state and in a state that power is being supplied to the motor;
determine diode losses of the top switch and the bottom switch based on the maximum value in the started state and in a state that power is being recovered from the motor; and
determine a transistor loss of the top switch or a transistor loss of the bottom switch based on a phase current measurement value of the motor in the constrained state.

8. The motor driving apparatus of claim 1, wherein the controller is further configured to:
determine a temperature variation of the at least one power module by multiplying the total power loss by a thermal resistance measurement value of the at least one power module; and
determine the temperature of the at least one power module by adding a coolant temperature of the at least one power module to the temperature variation.

9. The motor driving apparatus of claim 8, wherein the temperature variation corresponds to a product of the total power loss, the thermal resistance measurement value, and a coolant flow rate correction constant.

10. The motor driving apparatus of claim 9, wherein a value of the coolant flow rate correction constant decreases as a flow rate of a coolant increases.

11. A method for determining a temperature of at least one power module including at least one switch, in a driving unit which is implemented as the at least one power module and includes a top switch and a bottom switch configured to drive a motor based on a motor driving mode and a changeover switch configured to switch the motor driving mode, the method comprising:
determining a power loss of each of the top switch, the bottom switch, and the changeover switch based on the motor driving mode and an operation state of the motor to obtain a total power loss of the at least one power module; and
determining a temperature of the at least one power module based on the total power loss.

12. The method of claim 11, further including determining, based on a rotation speed of the motor, whether the operation state is a started state or a constrained state.

13. The method of claim 11, wherein the motor driving mode includes:
a first driving mode in which the top switch and the bottom switch are turned off, and the changeover switch is turned on to form a neutral point of the motor; and
a second driving mode in which the top switch and the bottom switch are switched complementarily to drive the motor, and the changeover switch is turned off.

14. The method of claim 13, wherein the obtaining of the total power loss includes:
determining the power loss of the changeover switch included in the total power loss in the first driving mode; and
determine the power losses of the top switch and the bottom switch included in the total power loss in the second driving mode.

15. The method of claim 14,
wherein the operation state of the motor in the first driving mode includes a started state and a constrained state, and
wherein the determining of the power loss of the changeover switch includes:
determining a transistor loss or a diode loss of the changeover switch based on a maximum value of a sinusoidal current conducted to the changeover switch in the started state; and
determining the transistor loss or the diode loss of the changeover switch based on a phase current measurement value of the motor in the constrained state.

16. The method of claim 14,
wherein the operation state of the motor in the second driving mode includes a started state and a constrained state, and
wherein the determining of the power losses of the top switch and the bottom switch includes:
determining transistor losses of the top switch and the bottom switch based on a maximum value of a sinusoidal current conducted to the top switch and the bottom switch, in the started state and in a state that power is being supplied to the motor;
determining diode losses of the top switch and the bottom switch based on the maximum value in the started state and in a state that power is being recovered from the motor; and
determining a transistor loss of the top switch or a transistor loss of the bottom switch based on a phase current measurement value of the motor in the constrained state.

17. The method of claim 11, wherein the determining of the temperature of the at least one power module includes:
determining a temperature variation of the at least one power module by multiplying the total power loss by a thermal resistance measurement value of the at least one power module; and
determining the temperature of the at least one power module by adding a coolant temperature of the at least one power module to the temperature variation.

18. The method of claim 17, wherein the temperature variation corresponds to a product of the total power loss, the thermal resistance measurement value, and a coolant flow rate correction constant.

19. The motor driving apparatus of claim 18, wherein a value of the coolant flow rate correction constant decreases as a flow rate of a coolant increases.
